(19) United States
(12) Patent Application Publication
(10) Pub. No.: US 2015/0381389 A1
(43) Pub. Date: Dec. 31, 2015

(54) USE OF TIME AUTO-CORRELATION FOR CHANNEL ESTIMATION

(71) Applicant: QUALCOMM Incorporated, San Diego, CA (US)

(72) Inventors: Jianqiang Zhang, Beijing (CN); Jilei Hou, Beijing (CN); Neng Wang, Beijing (CN); Xiaohui Liu, Beijing (CN); Liangming Wu, Beijing (CN)

(21) Appl. No.: 14/768,625

(22) PCT Filed: Apr. 2, 2013
(86) PCT No.: PCT/CN2013/073626

§ 371 Date: Aug. 18, 2015

(51) Int. Cl. H04L 25/02; H04L 5/14

(52) U.S. Cl. CPC H04L 25/0204; H04L 5/143; H04L 25/0228; H04L 25/0222

(57) ABSTRACT

Methods, systems, and apparatuses are described for channel estimation in wireless communications. The method, systems, and apparatuses operate in a time-division duplex (TDD) scheme. A first transmission may be received in a first sub-frame of a channel according to the TDD scheme. A time auto-correlation function may be applied to the first transmission to obtain a first auto-correlation sample. At least one characteristic of the channel may be estimated based at least in part on the first auto-correlation sample.

### BACKGROUND

The following relates generally to wireless communications, and more specifically to channel estimation in wireless communications. Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

Generally, a wireless multiple-access communication system may include a number of base stations, each simultaneously supporting communication for multiple mobile devices. Base stations may communicate with mobile devices using downstream and upstream links. Base stations may also communicate with mobile devices using frequency-division duplex (FDD) schemes and time-division duplex (TDD) schemes. Channel estimations, such as Doppler spread, are sometimes determined in a similar manner when operating in an FDD scheme or a TDD scheme. This may yield a useful channel estimation when operating in one scheme, but a less reliable channel estimation when operating in the other scheme.

### SUMMARY

The described features generally relate to one or more improved methods, systems, and/or apparatuses for channel estimation in wireless communications. The method, systems, and/or apparatuses may operate in a time-division duplex (TDD) scheme. In one embodiment, a first transmission may be received in a first sub-frame of a channel according to the TDD scheme. A time auto-correlation function may be applied to the first transmission to obtain a first auto-correlation sample. The time auto-correlation function may also be applied to a subset of transmissions received in one or more previous sub-frames. Applying the function to a subset of previous transmission may produce a number of auto-correlation samples. In one configuration, at least one characteristic of the channel may be estimated based at least in part on the auto-correlation samples. For example, a power spectrum density may be estimated for the first transmission using the auto-correlation samples. In addition, an estimated Doppler spread for the channel may be calculated based at least in part on the estimated power spectrum density

[[Remainder of this Section to be Added after Inventor Approval of the Claims]]

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communication system;

FIG. 2 shows a block diagram of a device in accordance with various embodiments;

FIG. 3 shows a block diagram of another device in accordance with various embodiments;

FIG. 4 shows a block diagram of yet another device in accordance with various embodiments;

FIG. 5 shows a block diagram of one more device in accordance with various embodiments;

FIG. 6 shows a diagram of an LTE/LTE-A TDD frame having a DSUUD downlink/uplink configuration and provides an example of lag values that may be identified for each of one or more previous sub-frames in relation to a first sub-frame;

FIG. 7 shows a diagram of an LTE/LTE-A TDD frame having a DSUUU downlink/uplink configuration and provides another example of lag values that may be identified for each of one or more previous sub-frames in relation to a first sub-frame;

FIG. 8 is a block diagram of a MIMO communication system in accordance with various embodiments;

FIG. 9 is a flowchart illustrating an embodiment of a method for channel estimation in wireless communications, in accordance with various embodiments;

FIG. 10 is a flowchart illustrating an embodiment of another method for channel estimation in wireless communications, in accordance with various embodiments; and

FIG. 11 is a flowchart illustrating an embodiment of yet another method for channel estimation in a wireless communications, in accordance with various embodiments.

### DETAILED DESCRIPTION

Channel estimation in wireless communications is described. In particular, channel estimation for a system or apparatus operating in a time-division duplex (TDD) scheme is described. Channel estimation may include, for example, estimating power spectrum density or Doppler spread.

An estimate of Doppler spread may be used to assess the rate of change of a wireless communication channel. Doppler spread may determine the rate of channel variation and fading type, and may be used for adaptive modulation, coding, and interleaving, channel tracker step-size selection at the receiver. An estimate of Doppler spread for a channel for may be used with network control algorithms, such as handoff and channel allocation in cellular systems.

A periodogram-based method may be commonly used for Doppler spread estimation. In an FDD system, such as an FDD LTE system, the receiver has a continuous estimate of channel impulse response. However, in a TDD system, such as a TDD LTE system, the receiver may not have a continuous estimate of channel impulse response. Using a periodogram-based method in a TDD system to estimate Doppler spread may yield a less reliable estimation. For example, the receiver in a TDD LTE system may receive downlink or special sub-frames separated by sub-frames reserved for uplink sub-frames. Because the uplink sub-frames may not be usable for Doppler spread estimation, a periodogram derived from the downlink or special sub-frames alone may be based on non-continuous samples. As a result, the use of non-continuous samples may yield a less than desirable channel estimation.

Described herein are methods, systems, and/or apparatuses for channel estimation in wireless communications, which method, systems, and/or apparatuses operate in a time-division duplex (TDD) scheme. In some configurations, a first transmission may be received in a first sub-frame of a channel according to the TDD scheme. A time auto-correlation function may then be applied to the first transmission to obtain a first auto-correlation sample. At least one characteristic of the channel may be estimated based at least in part on the first auto-correlation sample. Estimating the at least one characteristic of the channel may in some cases include 1) estimating a power spectrum density for the first transmission using the first auto-correlation sample; and 2) estimating a Doppler spread of the channel based at least in part on the estimated power spectrum density.

The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

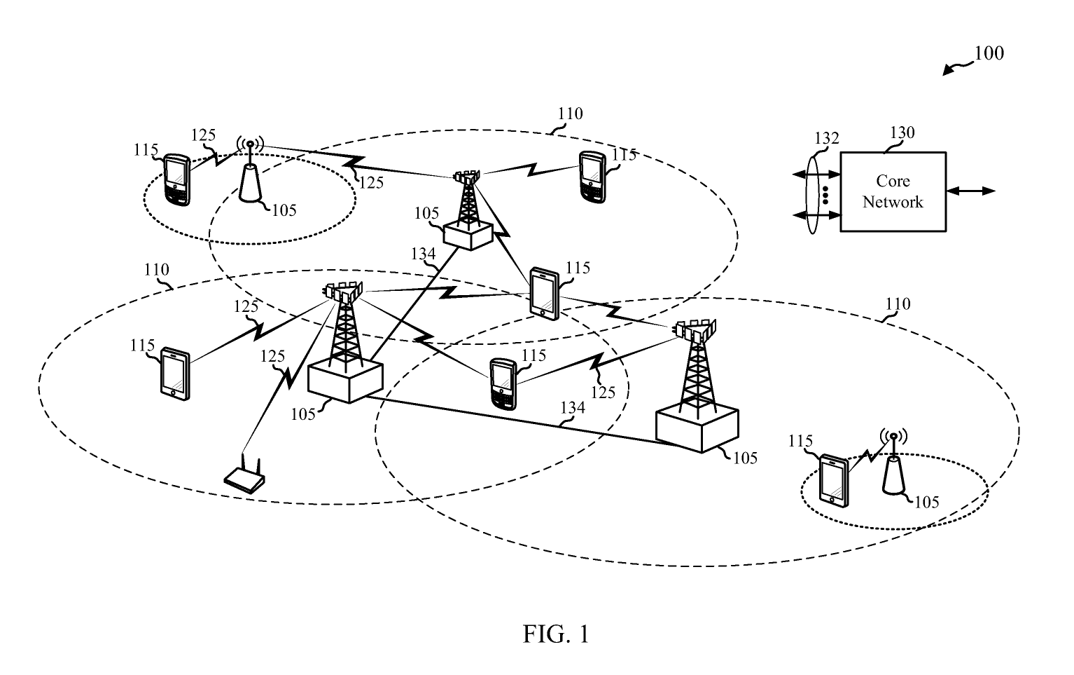

Referring first to FIG. 1, a diagram illustrates an example of a wireless communication system 100. The system 100 includes base stations (or cells) 105, mobile devices 115, and a core network 130. The base stations 105 may communicate with the mobile devices 115 under the control of a base station controller (not shown), which may be part of the core network 130 or the base stations 105 in various embodiments. Base stations 105 may communicate control information and/or user data with the core network 130 through backhaul links 132. In embodiments, the base stations 105 may communicate, either directly or indirectly, with each other over backhaul links 134, which may be wired or wireless communication links. The system 100 may support operation on multiple carriers (waveform signals of different frequencies). Multi-carrier transmitters can transmit modulated signals simultaneously on the multiple carriers. For example, each communication link 125 may be a multi-carrier signal modulated according to various radio technologies. Each modulated signal may be sent on a different carrier and may carry control information (e.g., reference signals, control channels, etc.), overhead information, data, etc.

The base stations 105 may wirelessly communicate with the mobile devices 115 via one or more base station antennas. Each of the base station 105 sites may provide communication coverage for a respective geographic area 110. In some embodiments, a base station 105 may be referred to as a base transceiver station, a radio base station, an access point, a radio transceiver, a basic service set (BSS), an extended service set (ESS), a NodeB, an eNodeB (eNB), a Home NodeB, a Home eNodeB, or some other suitable terminology. The coverage area 110 for a base station may be divided into sectors making up only a portion of the coverage area (not shown). The system 100 may include base stations 105 of different types (e.g., macro, micro, and/or pico base stations). There may be overlapping coverage areas for different technologies.

In embodiments, the system 100 may be an LTE/LTE-A system (or network). In LTE/LTE-A systems, the terms evolved Node B (eNB) and user equipment (UE) may be generally used to describe the base stations 105 and communication devices 115, respectively. The system 100 may also be a Heterogeneous LTE/LTE-A network in which different types of eNBs provide coverage for various geographical regions. For example, each eNB 105 may provide communication coverage for a macro cell, a pico cell, a femto cell, and/or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNB for a macro cell may be referred to as a macro eNB. An eNB for a pico cell may be referred to as a pico eNB. And, an eNB for a femto cell may be referred to as a femto eNB or a home eNB. An eNB may support one or multiple (e.g., two, three, four, and the like) cells.

The core network 130 may communicate with the eNBs 105 via a backhaul 132 (e.g., S1, etc.). The eNBs 105 may also communicate with one another, e.g., directly or indirectly via backhaul links 134 (e.g., X2, etc.) and/or via backhaul links 132 (e.g., through core network 130). The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for either synchronous or asynchronous operations.

The UEs 115 are dispersed throughout the wireless network 100, and each UE may be stationary or mobile. A mobile device or UE 115 may also be referred to by those skilled in the art as a mobile station, a subscriber station, a mobile unit, a subscriber unit, a wireless unit, a remote unit, a wireless device, a wireless communication device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with macro eNBs, pico eNBs, femto eNBs, relays, and the like.

The transmission links 125 shown in network 100 may include uplinks for carrying uplink (UL) transmissions (e.g., from a UE 115 to an eNB 105) and/or downlinks for carrying downlink (DL) transmission (e.g., from an eNB 105 to a UE 115). The DL transmissions may also be called forward link transmissions, while the UL transmissions may also be called reverse link transmissions.

Communication over one or more forward links may be further configured in accord with an FDD scheme or a TDD scheme. In an FDD scheme, uplink transmissions are sent over a first frequency channel and downlink transmissions are sent over a second frequency channel. In a TDD scheme, uplink and downlink transmissions are time-division multiplexed over a single frequency channel. In a TDD scheme, downlink transmissions may therefore be discontinuous, leading to difficulties with channel estimation. In one embodiment, time-auto correlation may be used in the TDD scheme to obtain one or more samples of the downlink transmissions. In one configuration, the samples may be used to perform channel estimation.

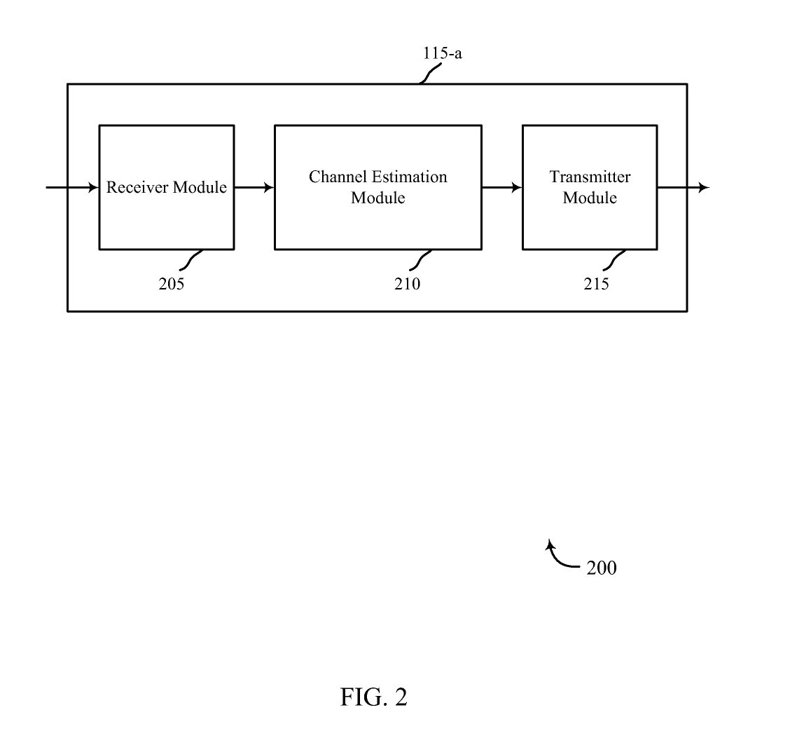

Referring now to FIG. 2, a block diagram 200 illustrates a device 115-a in accordance with various embodiments. The device 115-a may be an example of one or more aspects of one of the mobile devices 115 described with reference to FIG. 1. The device 115-a may also be a processor. The device 115-a may include a receiver module 205, a channel estimation module 210, and/or a transmitter module 215. Each of these components may be in communication with each other.

The components of the device 115-a may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver module 205 may be or include a cellular receiver, and in some cases may be or include an LTE/LTE-A receiver. The receiver module 205 may be used to receive various types of data and/or control signals (i.e., transmissions) over one or more communication channels of a wireless communication system, such as the wireless communication system 100 shown in FIG. 1.

The transmitter module 215 may be or include a cellular transmitter, and in some cases may be or include an LTE/LTE-A transmitter. The transmitter module 215 may be used to transmit various types of data and/or control signals over one or more communication channels of a wireless communication system, such as the wireless communication system 100.

The channel estimation module 210 may perform various functions and estimate one or more of various channel characteristics. In some embodiments, the channel estimation module 210 may determine whether the device 115-a is operating in a TDD scheme. If so, the channel estimation module 210 may receive a first transmission in a first sub-frame of a channel according to the TDD scheme. The first transmission may be received via the receiver module 205, and in some cases may be received via an LTE/LTE-A receiver of the receiver module 205. The channel estimation module 210 may further apply a time auto-correlation function to the first transmission to obtain a first auto-correlation sample, and may then estimate at least one characteristic of the channel based at least in part on the first auto-correlation sample.

In some embodiments, the channel estimation module 210 may further identify one or more previously received transmissions in one or more previous sub-frames of the channel. The channel estimation module 210 may then apply the time auto-correlation function to a subset of the identified one or more previously received transmissions to obtain one or more auto-correlation samples. At least one characteristic of the channel may be estimated based at least in part on the one or more auto-correlation samples, including the first auto-correlation sample.

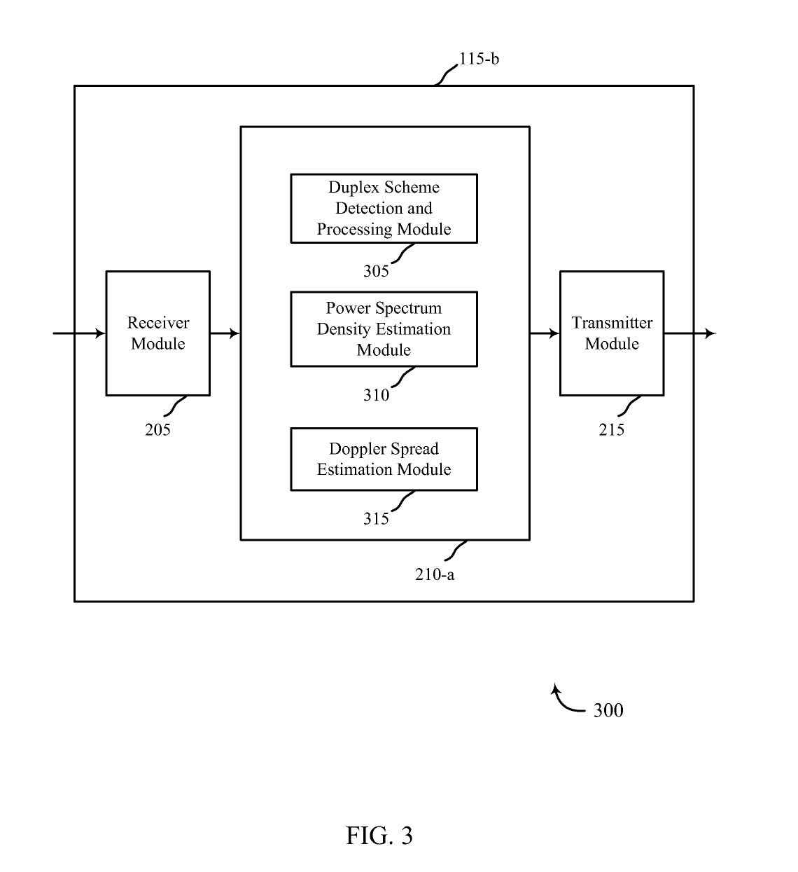

Referring now to FIG. 3, a block diagram 300 illustrates a device 115-b in accordance with various embodiments. The device 115-b may be an example of one or more aspects of one of the mobile devices 115 described with reference to FIGS. 1 and/or 2. The device 115-b may also be a processor. The device 115-b may include a receiver module 205, a channel estimation module 210-a, and/or a transmitter module 215. Each of these components may be in communication with each other.

The components of the device 115-b may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver module 205 and transmitter module 215 may be configured similarly to what is described with respect to FIG. 2. The channel estimation module 210-a may be an example of the channel estimation module 210 described with reference to FIG. 2 and may include a duplex scheme detection and processing module 305, a power spectrum density estimation module 310, and/or a Doppler spread estimation module 315. Each of these components may be in communication with each other.

The duplex scheme detection and processing module 305 may determine whether the device 115-b is operating in an FDD or TDD scheme. When the duplex scheme detection and processing module 305 determines that the device 115-b is operating in a TDD scheme, the module 305 may further determine the TDD scheme in which the device 115-b is operating. For example, if the device 115-b is configured for communication in an LTE/LTE-A system, the TDD scheme may assume one of various different downlink/uplink configurations. The particular TDD scheme in which the device 115-b is operating may determine how the time auto-correlation function is applied to one or more received transmissions.

The duplex scheme detection and processing module 305 may further receive a first transmission in a first sub-frame of a channel according to the TDD scheme. The first transmission may be received via the receiver module 205, and in some cases may be received via an LTE/LTE-A receiver of the receiver module 205. The module 305 may further apply a time auto-correlation function to the first transmission to obtain a first auto-correlation sample.

In some embodiments, the duplex scheme detection and processing module 305 may further identify one or more previously received transmissions in one or more previous sub-frames of the channel. The module 305 may then apply the time auto-correlation function to a subset of the identified one or more previously received transmissions to obtain one or more auto-correlation samples.

The duplex scheme detection and processing module 305 may further detect a switch from operating in a TDD scheme to operating in an FDD scheme. Upon detecting such a switch, the module 305 may cease to apply the time auto-correlation function to received transmissions.

The power spectrum density estimation module 310 may estimate the power spectrum density of a received transmission, based at least in part on the available auto-correlation samples. In some embodiments, the power spectrum density may be defined as the power of the received transmission per unit frequency, and may be expressed in watts. In some cases, the power spectrum density estimation module 310 may estimate the power spectrum density of a received transmission by computing a Fast Fourier Transform (FFT) of the auto-correlation function (e.g., based on the available auto-correlation samples) and then analyzing the FFT for periodicities in the frequency domain. Optionally, a shaping window may be used prior to computation of the FFT.

The Doppler spread estimation module 315 may estimate the Doppler spread of a channel based on the estimated power spectrum density. In some embodiments, the Doppler spread estimation module 315 may estimate the Doppler spread using a log-likelihood ratio method to match the estimated power spectrum density to one of a number of reference power spectrum densities, and then identifying (e.g., looking up) a Doppler spread corresponding to the reference power spectrum density that matches the estimated power spectrum density.

In some embodiments, the reference power spectrum densities may be calculated as follows. For a given downlink/uplink configuration, such as a DSUUD configuration in a TDD LTE system, the FFT of the sequence DSUUD may be computed, where D and S sub-frames are replaced with “1”s and U sub-frames are replaced with “0”s. The corresponding power spectrum density may be referred to as a covering pattern. For F_{d} (the maximum Doppler spread), and a given signal-to-noise ratio (SNR), a corresponding power spectrum density may be computed. The power spectrum density may then be circularly convoluted with the covering pattern. The resulting pattern may reflect the TDD nature of the DSUUD configuration. The set of some or all possible combinations of F_{d} and SNR may provide a set of reference power spectrum densities. The reference power spectrum densities may be calculated offline, in advance of when a device receives one or more transmissions to be processed for channel estimation.

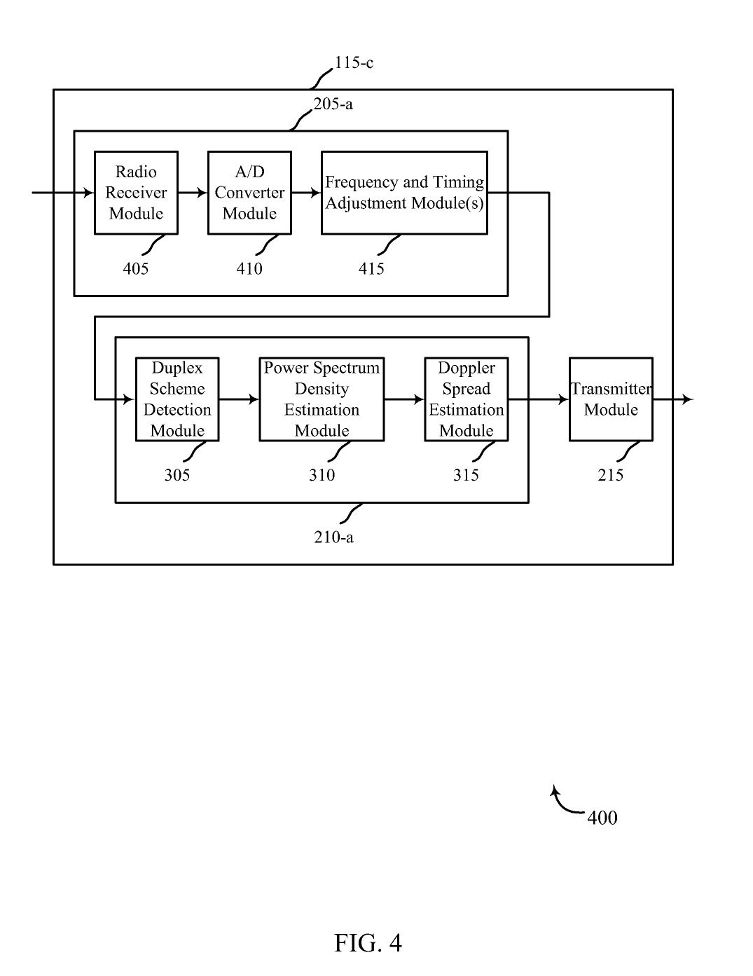

Referring now to FIG. 4, a block diagram 400 illustrates a device 115-c in accordance with various embodiments. The device 115-c may be an example of one or more aspects of one of the mobile devices 115 described with reference to FIGS. 1, 2, and/or 3. The device 115-c may also be a processor. The device 115-c may include a receiver module 205-a, a channel estimation module 210-b, and/or a transmitter module 215. Each of these components may be in communication with each other.

The components of the device 115-c may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver module 205-a may be an example of the receiver module 205 described with reference to FIGS. 2 and/or 3 and may include a radio receiver module 405, an analog-to-digital (A/D) converter module 410, and/or a frequency and timing adjustment module (or modules) 415. The channel estimation module 210-a may be configured similarly to what is described with reference to FIGS. 2 and/or 3 and may include a duplex scheme detection and processing module 305, a power spectrum density estimation module 310, and/or a Doppler spread estimation module 315. The transmitter module 215 may be configured similarly to what is described with respect to FIGS. 2 and/or 3. Each of these components may be in communication with each other.

The radio receiver module 405 may receive a transmission via one or more antennas of the device 115-c. The A/D converter module 410 may convert the received transmission to a sequence of digital samples. The frequency and timing adjustment module(s) 415 may then make any number of frequency and/or timing adjustments to the sequence of digital samples. The adjusted sequence of digital samples may be passed to the channel estimation module 210-a.

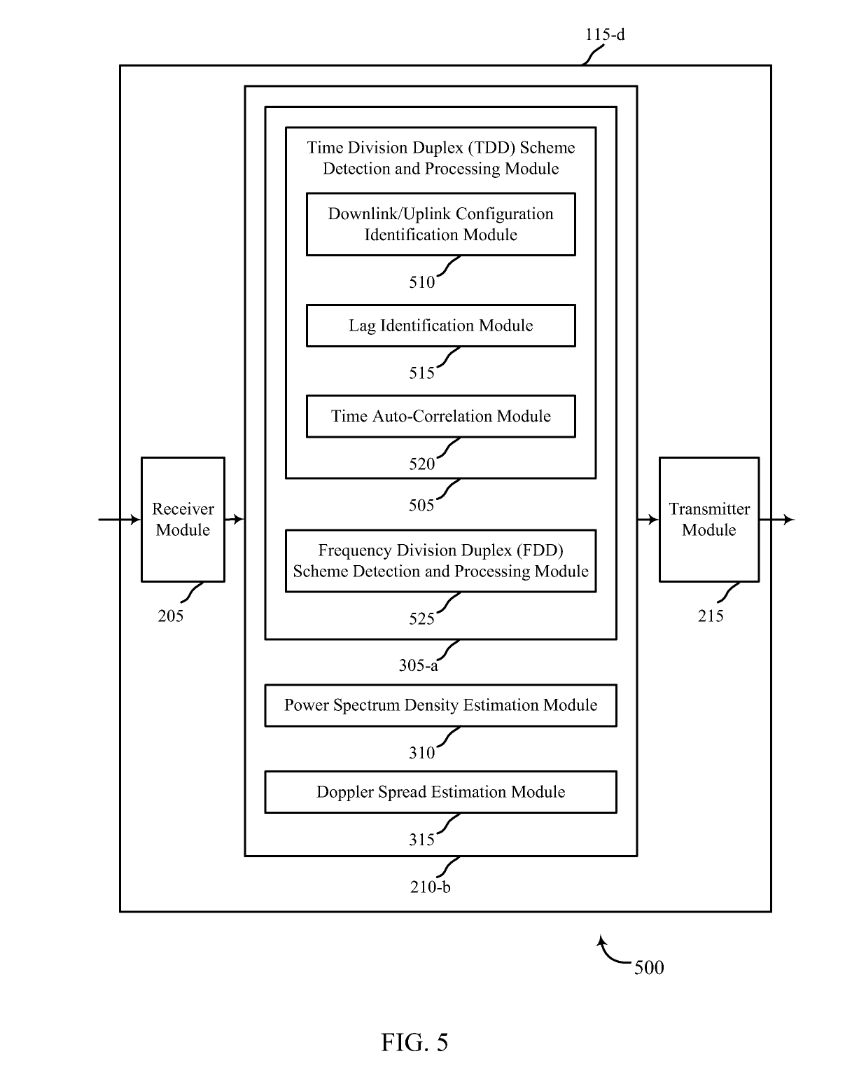

Referring now to FIG. 5, a block diagram 500 illustrates a device 115-d in accordance with various embodiments. The device 115-d may be an example of one or more aspects of one of the mobile devices 115 described with reference to FIGS. 1, 2, 3, and/or 4. The device 115-d may also be a processor. The device 115-d may include a receiver module 205, a channel estimation module 210-b, and/or a transmitter module 215. Each of these components may be in communication with each other.

The components of the device 115-d may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver module 205 and transmitter module 215 may be configured similarly to what is described with respect to FIGS. 2 and/or 4. The channel estimation module 210-b may be an example of the channel estimation module 210 described with reference to FIGS. 2, 3, and/or 4, and may include a duplex scheme detection and processing module 305-a, a power spectrum density estimation module 310, and/or a Doppler spread estimation module 315. Each of these components may be in communication with each other.

The duplex scheme detection and processing module 305-a may be an example of the duplex scheme detection and processing module 305 described with reference to FIGS. 3 and/or 4. In one example, the module 305-a may include a TDD scheme detection and processing module 505 and an FDD scheme detection and processing module 525. The TDD scheme detection and processing module 505 may determine when the device 115-d is operating in a TDD scheme and process received transmissions in accord with a first method or methods, such as a time auto-correlation method. The FDD scheme detection and processing module 525 may determine when the device 115-d is operating in an FDD scheme and process received transmissions in accord with a second method or methods, such as a periodogram-based method.

When the device 115-d is operating in a TDD scheme, a downlink/uplink configuration identification module 510 may identify a downlink/uplink configuration in which the device 115-d is operating (i.e., a downlink/uplink configuration of the TDD scheme). For example, if the device 115-d is configured for communication in an LTE/LTE-A system, the downlink/uplink configuration of the TDD scheme may assume one of seven different configurations. In a first configuration, each half-frame of an LTE frame assumes a configuration including a first downlink sub-frame, a special sub-frame, a first uplink sub-frame, a second uplink sub-frame, and a second downlink sub-frame (a DSUUD configuration). In a second configuration, each half-frame assumes a configuration including a first downlink sub-frame, a special sub-frame, a first uplink sub-frame, a second uplink sub-frame, and a third uplink sub-frame (a DSUUU configuration). In a third configuration, each half-frame assumes a configuration including a first downlink sub-frame, a special sub-frame, an uplink sub-frame, a second downlink sub-frame, and a third downlink sub-frame (a DSUDD configuration). In other configurations, the full LTE frame may assume a DSUUUDDDDD, a DSUUDDDDDD, a DSUDDDDDDD, or a DSUUUDSUUD configuration.

The downlink/uplink configuration identified by the module 510 may determine the operation of a lag identification module 515 and/or a time auto-correlation module 520. In one embodiment, the time auto-correlation module 520 may receive a first transmission in a first sub-frame of a channel according to the TDD scheme. The first transmission may be received via the receiver module 205, and in some cases may be received via an LTE/LTE-A receiver of the receiver module 205. The module 520 may apply a time auto-correlation function to the first transmission to obtain a first auto-correlation sample. In some embodiments, the module 520 may further identify one or more previously received transmissions in one or more previous sub-frames of the channel, and may apply the time auto-correlation function to a subset of the identified one or more previously received transmissions to obtain one or more auto-correlation samples (i.e., one or more additional auto-correlation samples).

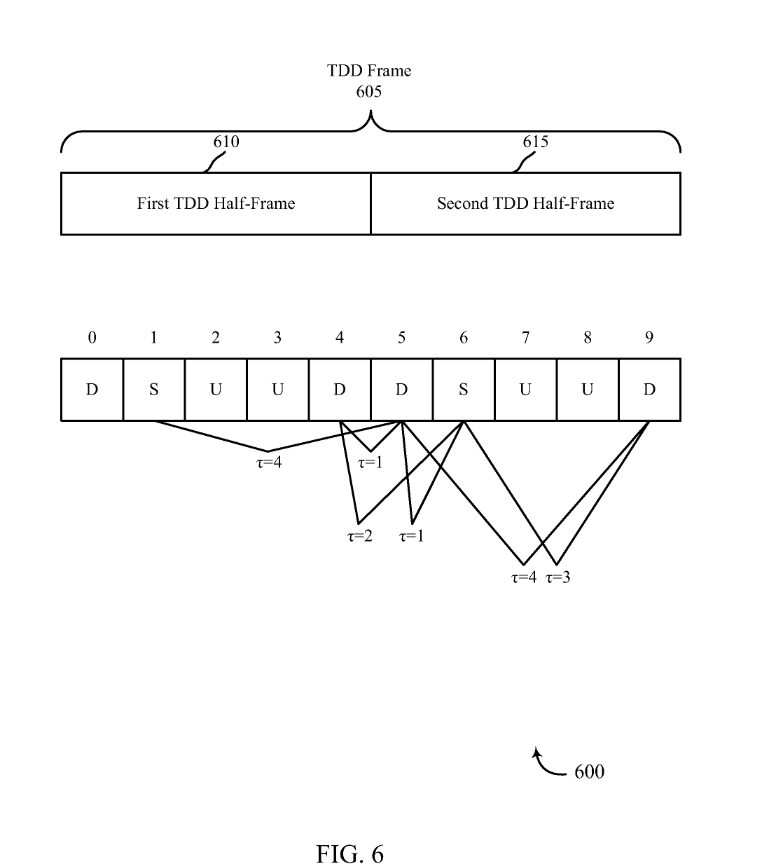

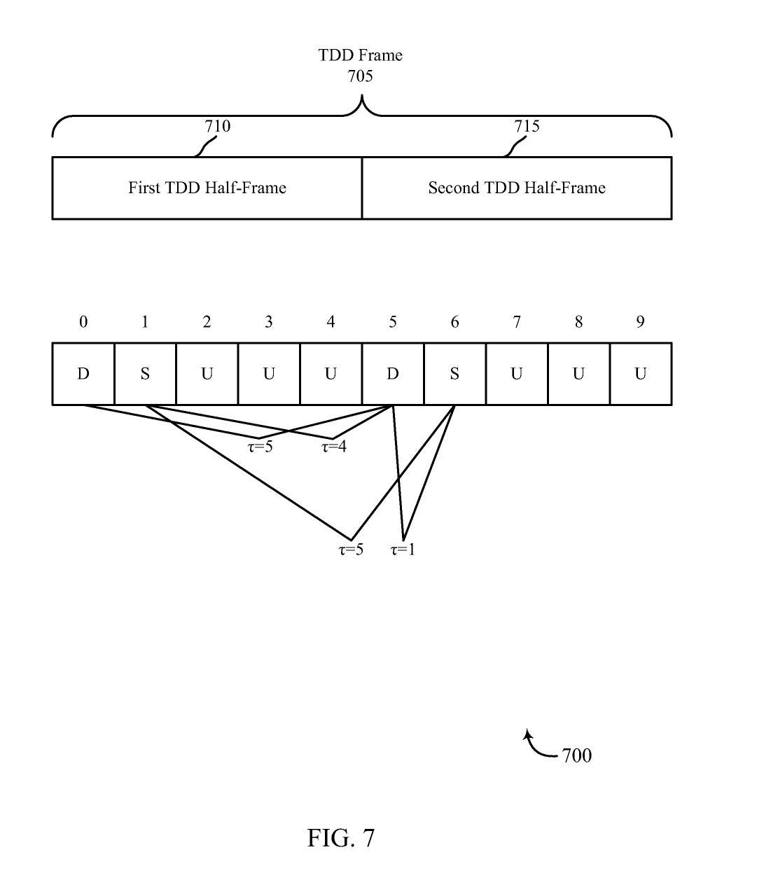

The lag identification module 515 may assist in identifying the one or more previously received transmissions. In particular, the lag identification module 515 may identify a lag value for each of the one or more previous sub-frames in relation to the first sub-frame. Such an identification of lag values will be described in greater detail below, with reference to FIGS. 6 and 7. The subset of the identified one or more previously received transmissions may be identified based at least in part on the lag value for each of the one or more previous sub-frames.

In some embodiments, the time auto-correlation function applied by the module 520 may be applied to transmissions received in at least one downlink sub-frame or at least one special sub-frame to obtain the indicated auto-correlation samples. The module 520 may bypass application of the time auto-correlation function to transmissions in at least one uplink sub-frame.

The power spectrum density estimation module 310 and Doppler spread estimation module 315 may be configured similarly to what is described with respect to FIG. 3.

The time-domain auto-correlation function \hat{R}(τ) may be expressed as:

$$\hat{R} ( τ ) = {E}_{t - τ ∈ \{ D , S \} \& t ∈ \{ D , S \}} \{ \hat{h} ( t - τ ) \cdot {\hat{h}}^{*} ( t ) \}$$

where ĥ(t) denotes the channel estimate sequence, D denotes a downlink sub-frame, and S denotes a special sub-frame. Uplink sub-frames U may not contribute to the time-domain auto-correlation function.

Referring now to FIG. 6, a diagram 600 of an LTE/LTE-A TDD frame 605 having a DSUUD downlink/uplink configuration illustrates an example of lag values that may be identified for each of one or more previous sub-frames in relation to a first sub-frame. In one configuration, sub-frame 5, a downlink (D) sub-frame, may be a first sub-frame. Previously received transmissions may be identified in sub-frame 4 (a D sub-frame), sub-frame 1 (a special sub-frame), and sub-frame 0 (another D sub-frame). As a result, sub-frame 4 may have a lag value of one (τ=1) with respect to sub-frame 5. Sub-frame 1 may have a lag value of four (τ=4) with respect to sub-frame 5. Sub-frame 0 may have a lag value of five (τ=5) with respect to sub-frame 5. For clarity, the lag value of five is not shown in FIG. 6.

As another example, sub-frame 6, a special (S) sub-frame, may be the first sub-frame. Previously received transmissions may be identified in sub-frame 5 (a D sub-frame), sub-frame 4 (another D sub-frame), sub-frame 1 (a special sub-frame), and sub-frame 0 (another D sub-frame). In this example, sub-frame 5 may have a lag value of one (τ=1) with respect to sub-frame 6. Sub-frame 4 may have a lag value of two (τ=2) with respect to sub-frame 6. Sub-frame 1 may have a lag value of five (τ=5) with respect to sub-frame 6. Sub-frame 0 may have a lag value of six (τ=6) with respect to sub-frame 6. For clarity, the lag values of five and six are not shown in FIG. 6.

The lag values may be used to identify the subsets of previously received transmissions (or sub-frames) for which auto-correlation samples may be obtained. More generally, and assuming that a history of sixteen previously received transmissions is available, an auto-correlation function may be applied to obtain auto-correlation samples at the following lag values:

| Sub- | Lag Values of Auto-Correlation Function | | | | | | | | | | | | | | | | |
|---|---|---|---|---|---|---|---|---|---|---|---|---|---|---|---|---|---|
| frames | 0 | 1 | 2 | 3 | 4 | 5 | 6 | 7 | 8 | 9 | 10 | 11 | 12 | 13 | 14 | 15 | 16 |
| D | X | X | | | X | X | X | | | X | X | X | | | X | X | X |
| S | X | X | X | | | X | X | X | | | X | X | X | | | X | X |
| U | | | | | | | | | | | | | | | | | |
| U | | | | | | | | | | | | | | | | | |
| D | X | | | X | X | X | | | X | X | X | | | X | X | X | |

The above table illustrates that, at sub-frame 5 of FIG. 6, auto-correlation samples may be available at lags of τ=0, 1, 4, 5, 6, 9, 10, 11, 14, 15, and 16. At sub-frame 6, auto-correlation samples may be available at lags of τ=0, 1, 2, 5, 6, 7, 10, 11, 12, 15, and 16. At sub-frame 9, auto-correlation samples may be available at lags of τ=0, 3, 4, 5, 8, 9, 10, 13, 14, and 15.

From another perspective, there are different numbers of auto-correlation samples available for different lag values. That is, there are three auto-correlation samples available for lag values of τ=0, 5, 10, and 15; two samples available for lag values of τ=1, 4, 6, 9, 11, 14, and 16; and only one sample for τ=2, 3, 7, 8, 12, and 13. Thus, for the case of a DSUUD downlink/uplink configuration, all lag values (0-16) are associated with a respective set of auto-correlation samples. This may not be the case for all downlink/uplink configurations.

Referring now to FIG. 7, a diagram 700 of an LTE/LTE-A TDD frame 705 having a DSUUU downlink/uplink configuration illustrates another example of how lag values may be identified for each of one or more previous sub-frames in relation to a first sub-frame. In one example, sub-frame 5, a downlink (D) sub-frame, may be a first sub-frame. Previously received transmissions may be identified in sub-frame 1 (an S sub-frame), and sub-frame 0 (a D sub-frame). Sub-frame 1 may have a lag value of four (τ=4) with respect to sub-frame 5. Sub-frame 0 may have a lag value of five (τ=5) with respect to sub-frame 5.

In another example, sub-frame 6, a special (S) sub-frame, may be the first sub-frame. Previously received transmissions may be identified in sub-frame 5 (a D sub-frame), sub-frame 1 (a special sub-frame), and sub-frame 0 (yet another D sub-frame). Sub-frame 5 may have a lag value of one (τ=1) with respect to sub-frame 6. Sub-frame 1 may have a lag value of five (τ=5) with respect to sub-frame 6. Sub-frame 0 may have a lag value of six (τ=6) with respect to sub-frame 6. For clarity, the lag value of six is not shown in FIG. 7.

The lag values may be used to identify the subsets of previously received transmissions (or sub-frames) for which auto-correlation samples may be obtained. More generally, and assuming that a history of sixteen previously received transmissions is available, an auto-correlation function may be applied to obtain auto-correlation samples at the following lag values:

| Sub- | Lag Values of Auto-Correlation Function | | | | | | | | | | | | | | | | |
|---|---|---|---|---|---|---|---|---|---|---|---|---|---|---|---|---|---|
| frames | 0 | 1 | 2 | 3 | 4 | 5 | 6 | 7 | 8 | 9 | 10 | 11 | 12 | 13 | 14 | 15 | 16 |

| | | | | | | | | | | | |
|---|---|---|---|---|---|---|---|---|---|---|---|
| D | X | | X | X | | X | X | | X | X | |
| S | X | X | | X | X | | X | X | | X | X |
| U | | | | | | | | | | | |
| U | | | | | | | | | | | |
| U | | | | | | | | | | | |

The above table illustrates that there are different numbers of auto-correlation samples available for different lag values. That is, there are two auto-correlation samples available for lag values of τ=0, 5, 10, and 15; one sample available for lag values of τ=1, 4, 6, 9, 11, 14, and 16; and no samples available for τ=2, 3, 7, 8, 12, and 13. Thus, for the case of a DSUUU downlink/uplink configuration, some lag values are not associated with a respective set of auto-correlation samples and the auto-correlation function may be discontinuous. To obtain a continuous auto-correlation function, a time-domain interpolation may be performed on the channel estimate sequence ĥ(t) or the resulting auto-correlation function. While only two downlink/uplink configuration are illustrated, it is to be understood that the present systems and methods may use time-auto correlation to perform channel estimation with additional downlink/uplink configurations in TDD LTE systems.

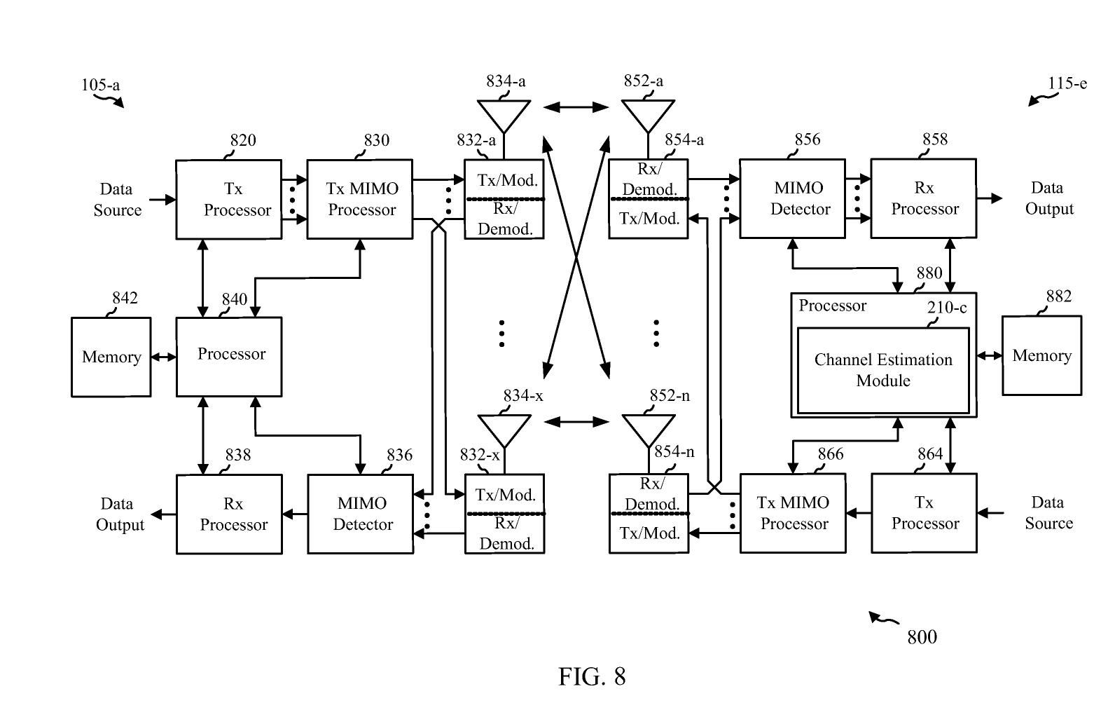

FIG. 8 is a block diagram of a MIMO communication system 800 including a base station 105-a and a mobile device 115-e. This system 800 may illustrate aspects of the system 100 of FIG. 1. The base station 105-a may be equipped with antennas 834-a through 834-x, and the mobile device 115-e may be equipped with antennas 852-a through 852-n. In the system 800, the base station 105-a may be able to send data over multiple communication links at the same time. Each communication link may be called a “layer” and the “rank” of the communication link may indicate the number of layers used for communication. For example, in a 2×2 MIMO system where base station 105-a transmits two “layers,” the rank of the communication link between the base station 105-a and the UE 115-e is two.

At the base station 105-a, a transmit processor 820 may receive data from a data source. The transmit processor 820 may process the data. The transmit processor 820 may also generate control symbols and/or reference symbols. A transmit (TX) MIMO processor 830 may perform spatial processing (e.g., precoding) on data symbols, control symbols, and/or reference symbols, if applicable, and may provide output symbol streams to the transmit modulators 832-a through 832-x. Each modulator 832 may process a respective output symbol stream (e.g., for OFDM, etc.) to obtain an output sample stream. Each modulator 832 may further process (e.g., convert to analog, amplify, filter, and upconvert) the output sample stream to obtain a DL signal. In one example, DL signals from modulators 832-a through 832-x may be transmitted via the antennas 834-a through 834-x, respectively.

At the mobile device 115-e, the mobile device antennas 852-a through 852-n may receive the DL signals from the base station 105-a and may provide the received signals to the demodulators 854-a through 854-n, respectively. Each demodulator 854 may condition (e.g., filter, amplify, downconvert, and digitize) a respective received signal to obtain input samples. Each demodulator 854 may further process the input samples (e.g., for OFDM, etc.) to obtain received symbols. A MIMO detector 856 may obtain received symbols from all the demodulators 854-a through 854-n, perform MIMO detection on the received symbols, if applicable, and provide detected symbols. A receive processor 858 may process (e.g., demodulate, deinterleave, and decode) the detected symbols, providing decoded data for the mobile device 115-e to a data output, and provide decoded control information to a processor 880, or memory 882.

The processor 880 may in some cases execute stored instructions to instantiate a channel estimation module 210-d. In some embodiments, the channel estimation module 210-d may determine that the mobile device 115-e is operating in a TDD scheme and receive transmissions on one or more communication links or channels according to the TDD scheme. The transmissions may be received via the receive processor 858. For each of one or more of the channels, the channel estimation module 210-d may apply a time auto-correlation function to one or more of the transmissions to obtain one or more auto-correlation samples. The one or more auto-correlation samples may then be used to estimate at least one characteristic of the channel, such as a power spectrum density or a Doppler spread.

On the uplink (UL), at the mobile device 115-e, a transmit processor 864 may receive and process data from a data source. The received data may in some cases include the estimated characteristic(s) of one or more communication channels. The transmit processor 864 may also generate reference symbols for a reference signal. The symbols from the transmit processor 864 may be precoded by a transmit MIMO processor 866 if applicable, further processed by the demodulators 854-a through 854-n (e.g., for SC-FDMA, etc.), and be transmitted to the base station 105-a in accordance with the transmission parameters received from the base station 105-a. At the base station 105-a, the UL signals from the mobile device 115-e may be received by the antennas 834, processed by the demodulators 832, detected by a MIMO detector 836 if applicable, and further processed by a receive processor. The receive processor 838 may provide decoded data to a data output and to the processor 840.

The components of the mobile device 115-e may, individually or collectively, be implemented with one or more Application Specific Integrated Circuits (ASICs) adapted to perform some or all of the applicable functions in hardware. Each of the noted modules may be a means for performing one or more functions related to operation of the system 800. Similarly, the components of the base station 105-a may, individually or collectively, be implemented with one or more Application Specific Integrated Circuits (ASICs) adapted to perform some or all of the applicable functions in hardware. Each of the noted components may be a means for performing one or more functions related to operation of the system 800.

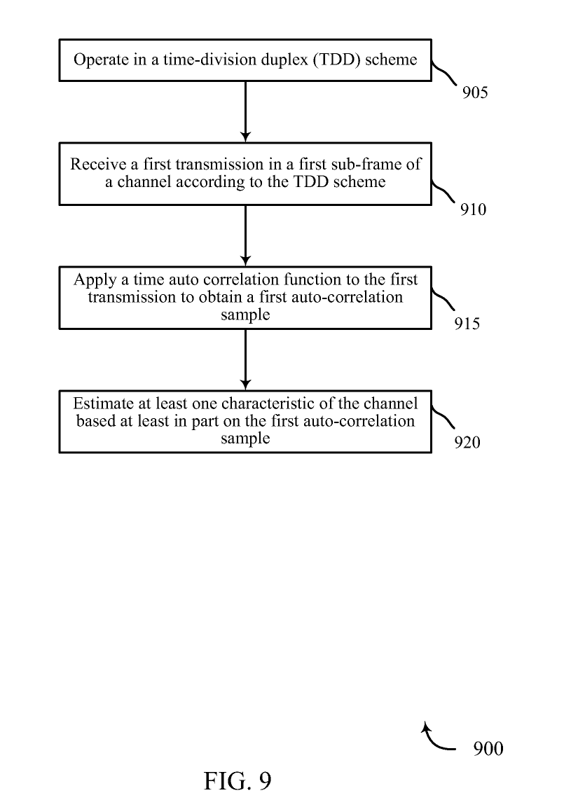

FIG. 9 is a flow chart illustrating an embodiment of a method 900 for channel estimation in wireless communications. For clarity, the method 900 is described below with reference to the wireless communication system 100 or 800 shown in FIGS. 1 and/or 8, and/or with reference to one of the devices 115 described with reference to FIGS. 1, 2, 3, 4, 5, and/or 8. In one implementation, the channel estimation module 210 described with reference to FIGS. 2, 3, 4, 5, and/or 8 may execute one or more sets of codes to control the functional elements of a device 115 to perform the functions described below.

The method operates in a TDD scheme at block 905. In some cases, a device 115 or other apparatus capable of performing the method 900 may be operating in an FDD scheme and switch to a TDD scheme just prior to block 905, at which time execution of the method 900 may be triggered. In other cases, a device 115 or other apparatus capable of performing the method 900 may experience an event such as a power on or boot procedure just prior to block 905, at which time execution of the method 900 may be triggered. Operation in a TDD scheme may be detected, in some cases, by the duplex scheme detection and processing module 305 described with reference to FIGS. 3, 4, and/or 5.

At block 910, a first transmission may be received in a first sub-frame of a channel according to the TDD scheme. In some cases, the first sub-frame may be part of a half-frame configured according to the TDD scheme. For example, the half-frame may include a first downlink sub-frame, a special sub-frame, a first uplink sub-frame, a second uplink sub-frame, and a second downlink sub-frame (a DSUUD configuration), or the half-frame may include a first downlink sub-frame, a special sub-frame, a first uplink sub-frame, a second uplink sub-frame, and a third uplink sub-frame (a DSUUU configuration). The TDD scheme and half-frame may also assume other configurations, such as any of the TDD scheme or half-frame configurations supported by an LTE/LTE-A system.

At block 915, a time auto-correlation function may be applied to the first transmission to obtain a first auto-correlation sample. In some embodiments, the operations at block 915 may be performed by the time auto-correlation module 520 described with reference to FIG. 5.

At block 920, at least one characteristic of the channel may be estimated based at least in part on the first auto-correlation sample. The at least one estimated characteristic may include, for example, an estimated power spectrum density and/or an estimated Doppler spread of the channel.

The operations at blocks 905, 910, 915, and/or 920 may be repeated at discrete times or periodically, and in some cases may be overlapped. At some point, a switch from operating in the TDD scheme to operating in a FDD scheme may be detected. Upon detecting such a switch, application of the time auto-correlation function to a received transmission may cease.

Therefore, the method 900 may be used for channel estimation in wireless communications. It should be noted that the method 900 is just one implementation and that the operations of the method 900 may be rearranged or otherwise modified such that other implementations are possible.

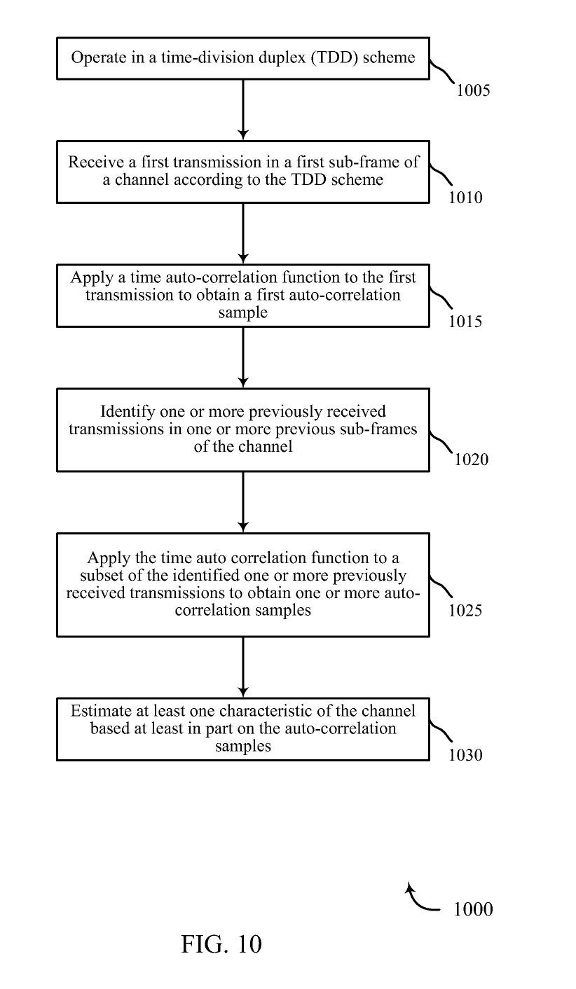

FIG. 10 is a flow chart illustrating an embodiment of another method 1000 for channel estimation in wireless communications. For clarity, the method 1000 is described below with reference to the wireless communication system 100 or 800 shown in FIGS. 1 and/or 8, and/or with reference to one of the devices 115 described with reference to FIGS. 1, 2, 3, 4, 5, and/or 8. In one implementation, the channel estimation module 210 described with reference to FIGS. 2, 3, 4, 5, and/or 8 may execute one or more sets of codes to control the functional elements of a device 115 to perform the functions described below.

The method operates in a TDD scheme at block 1005. In some cases, a device 115 or other apparatus capable of performing the method 1000 may be operating in an FDD scheme and switch to a TDD scheme just prior to block 1005, at which time execution of the method 1000 may be triggered. In other cases, a device 115 or other apparatus capable of performing the method 1000 may experience an event such as a power on or boot procedure just prior to block 1005, at which time execution of the method 1000 may be triggered. Operation in a TDD scheme may be detected, in some cases, by the duplex scheme detection and processing module 305 described with reference to FIGS. 3, 4, and/or 5.

At block 1010, a first transmission may be received in a first sub-frame of a channel according to the TDD scheme. In some cases, the first sub-frame may be part of a half-frame configured according to the TDD scheme. For example, the half-frame may include a first downlink sub-frame, a special sub-frame, a first uplink sub-frame, a second uplink sub-frame, and a second downlink sub-frame (a DSUUD configuration), or the half-frame may include a first downlink sub-frame, a special sub-frame, a first uplink sub-frame, a second uplink sub-frame, and a third uplink sub-frame (a DSUUU configuration). The TDD scheme and half-frame may also assume other configurations, such as any of the TDD scheme or half-frame configurations supported by an LTE/LTE-A system.

At block 1015, a time auto-correlation function may be applied to the first transmission to obtain a first auto-correlation sample. In some embodiments, the operations at block 1015 may be performed by the time auto-correlation module 520 described with reference to FIG. 5. Also, and in some embodiments, the time auto-correlation function may be applied to transmissions received in at least one downlink sub-frame or at least one special sub-frame. Application of the time auto-correlation function may be bypassed for transmissions in at least one uplink sub-frame.

At block 1020, one or more previously received transmissions in one or more previous sub-frames of the channel may be identified. The one or more previously received transmissions may be identified in at least one downlink sub-frame or at least one special sub-frame.

At block 1025, the time auto-correlation function may be applied to a subset of the identified one or more previously received transmissions to obtain one or more auto-correlation samples. The subset of the identified one or more previously received transmissions may in some cases be identified as transmissions received in at least one downlink sub-frame or at least one special sub-frame.

At block 1030, at least one characteristic of the channel may be estimated based at least in part on 1) the first auto-correlation sample obtained by applying the time auto-correlation function to the first transmission, and/or 2) the one or more auto-correlation samples obtained by applying the time auto-correlation function to the one or more previously received transmissions. The at least one estimated characteristic may include, for example, an estimated power spectrum density and/or an estimated Doppler spread of the channel.

The operations at blocks 1005, 1010, 1015, 1020, 1025, and/or 1030 may be repeated at discrete times or periodically, and in some cases may be overlapped. At some point, a switch from operating in the TDD scheme to operating in a FDD scheme may be detected. Upon detecting such a switch, application of the time auto-correlation function to a received transmission may cease.

Therefore, the method 1000 may be used for channel estimation in wireless communications. It should be noted that the method 1000 is just one implementation and that the operations of the method 1000 may be rearranged or otherwise modified such that other implementations are possible.

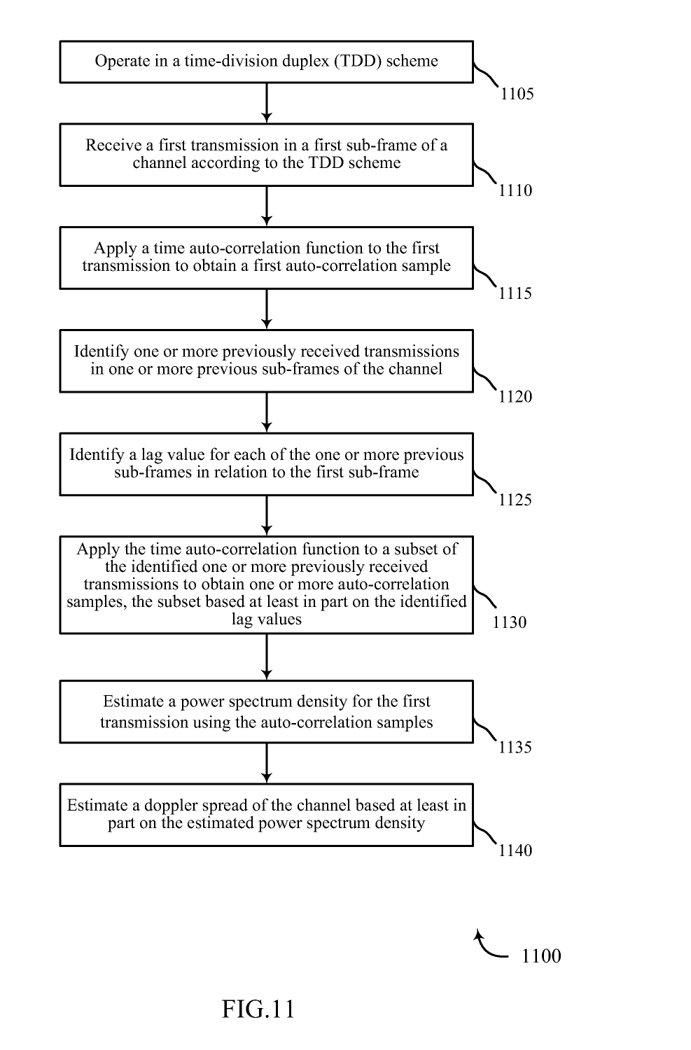

FIG. 11 is a flow chart illustrating an embodiment of another method 1100 for channel estimation in wireless communications. For clarity, the method 1100 is described below with reference to the wireless communication system 100 or 800 shown in FIGS. 1 and/or 8, and/or with reference to one of the devices 115 described with reference to FIGS. 1, 2, 3, 4, 5, and/or 8. In one implementation, the channel estimation module 210 described with reference to FIGS. 2, 3, 4, 5, and/or 8 may execute one or more sets of codes to control the functional elements of a device 115 to perform the functions described below.

The method operates in a TDD scheme at block 1105. In some cases, a device 115 or other apparatus capable of performing the method 1100 may be operating in an FDD scheme and switch to a TDD scheme just prior to block 1105, at which time execution of the method 1100 may be triggered. In other cases, a device 115 or other apparatus capable of performing the method 1100 may experience an event such as a power on or boot procedure just prior to block 1105, at which time execution of the method 1100 may be triggered. Operation in a TDD scheme may be detected, in some cases, by the duplex scheme detection module 305 described with reference to FIGS. 3, 4, and/or 5.

At block 1110, a first transmission may be received in a first sub-frame of a channel according to the TDD scheme. In some cases, the first sub-frame may be part of a half-frame configured according to the TDD scheme. For example, the half-frame may include a first downlink sub-frame, a special sub-frame, a first uplink sub-frame, a second uplink sub-frame, and a second downlink sub-frame (a DSUUD configuration), or the half-frame may include a first downlink sub-frame, a special sub-frame, a first uplink sub-frame, a second uplink sub-frame, and a third uplink sub-frame (a DSUUU configuration). The TDD scheme and half-frame may also assume other configurations, such as any of the TDD scheme or half-frame configurations supported by an LTE/LTE-A system.

At block 1115, a time auto-correlation function may be applied to the first transmission to obtain a first auto-correlation sample. In some embodiments, the operations at block 1115 may be performed by the time auto-correlation module 520 described with reference to FIG. 5. Also, and in some embodiments, the time auto-correlation function may be applied to transmissions received in at least one downlink sub-frame or at least one special sub-frame. Application of the time auto-correlation function may be bypassed for transmissions in at least one uplink sub-frame.

At block 1120, one or more previously received transmissions in one or more previous sub-frames of the channel may be identified. The one or more previously received transmissions may be identified in at least one downlink sub-frame or at least one special sub-frame.

At block 1125, a lag value may be identified for each of the one or more previous sub-frames in relation to the first sub-frame. The operations at block 1125 may in some cases be performed by the lag identification module 515 described with reference to FIG. 5.

At block 1130, the time auto-correlation function may be applied to a subset of the identified one or more previously received transmissions to obtain one or more auto-correlation samples. The subset of previously received transmissions to which the time auto-correlation may be identified based at least in part on the lag value for each of the one or more previous sub-frames. The subset of previously received transmissions may also, in some cases, be identified as transmissions received in at least one downlink sub-frame or at least one special sub-frame. The operations at block 1130 may in some cases be performed by the time auto-correlation module 520 described with reference to FIG. 5.

At blocks 1135 and 1140, at least one characteristic of the channel may be estimated based at least in part on 1) the first auto-correlation sample obtained by applying the time auto-correlation function to the first transmission, and/or 2) the one or more auto-correlation samples obtained by applying the time auto-correlation function to the one or more previously received transmissions. For example, at block 1135, a power spectrum density for the first transmission may be estimated using the auto-correlation samples, and at block 1140, the Doppler spread of the channel may be estimated. The Doppler spread may be estimated based at least in part on the estimated power spectrum density (i.e., estimated based on the auto-correlation samples indirectly).

The operations at blocks 1105, 1110, 1115, 1120, 1125, 1130, 1135 and/or 1140 may be repeated at discrete times or periodically, and in some cases may be overlapped. At some point, a switch from operating in the TDD scheme to operating in a FDD scheme may be detected. Upon detecting such a switch, application of the time auto-correlation function to a received transmission may cease.

Therefore, the method 1100 may be used for channel estimation in wireless communications. It should be noted that the method 1100 is just one implementation and that the operations of the method 1100 may be rearranged or otherwise modified such that other implementations are possible.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Techniques described herein may be used for various wireless communication systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS. LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description below, however, describes an LTE system for purposes of example, and LTE terminology is used in much of the description below, although the techniques are applicable beyond LTE applications.

The communication networks that may accommodate some of the various disclosed embodiments may be packet-based networks that operate according to a layered protocol stack. For example, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARM) to provide retransmission at the MAC layer to improve link efficiency. At the Physical layer, the transport channels may be mapped to Physical channels.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration. A processor may in some cases be in electronic communication with a memory, where the memory stores instructions that are executable by the processor.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

A computer program product or computer-readable medium both include a computer-readable storage medium and communication medium, including any mediums that facilitates transfer of a computer program from one place to another. A storage medium may be any medium that can be accessed by a general purpose or special purpose computer. By way of example, and not limitation, computer-readable medium can comprise RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for channel estimation in wireless communications, comprising:
operating in a time-division duplex (TDD) scheme;
receiving a first transmission in a first sub-frame of a channel according to the TDD scheme;
applying a time auto-correlation function to the first transmission to obtain a first auto-correlation sample; and
estimating at least one characteristic of the channel based at least in part on the first auto-correlation sample.

2. The method of claim 1, wherein estimating the at least one characteristic of the channel comprises:
estimating a power spectrum density for the first transmission using the first auto-correlation sample; and
estimating a Doppler spread of the channel based at least in part on the estimated power spectrum density.

3. The method of claim 1, further comprising:
identifying one or more previously received transmissions in one or more previous sub-frames of the channel;
applying the time auto-correlation function to a subset of the identified one or more previously received transmissions to obtain one or more auto-correlation samples; and
estimating the at least one characteristic of the channel based at least in part on the one or more auto-correlation samples.

4. The method of claim 3, wherein identifying the one or more previously received transmissions in the one or more previous sub-frames comprises:
identifying one or more previously received transmissions in at least one downlink sub-frame or at least one special sub-frame.

5. The method of claim 3, further comprising:
identifying a lag value for each of the one or more previous sub-frames in relation to the first sub-frame.

6. The method of claim 5, further comprising:
identifying the subset of the identified one or more previously received transmissions based at least in part on the lag value for each of the one or more previous sub-frames.

7. The method of claim 3, further comprising:
identifying the subset of the identified one or more previously received transmissions as transmissions received in at least one downlink sub-frame or at least one special sub-frame.

8. The method of claim 1, further comprising:
applying the time auto-correlation function to transmissions received in at least one downlink sub-frame or at least one special sub-frame to obtain auto-correlation samples.

9. The method of claim 1, further comprising:
bypassing an application of the time auto-correlation function to transmissions in at least one uplink sub-frame.

10. The method of claim 1, further comprising:
detecting a switch from operating in the TDD scheme to operating in a frequency division duplex (FDD) scheme.

11. The method of claim 10, further comprising:
upon detecting the switch to operating in the FDD scheme, ceasing to apply the time auto-correlation function to a received transmission.

12. The method of claim 1, wherein the first sub-frame is part of a half-frame having a configuration according to the TDD scheme.

13. The method of claim 12, wherein the half-frame comprises a first downlink sub-frame, a special sub-frame, a first uplink sub-frame, a second uplink sub-frame, and a second downlink sub-frame (a DSUUD configuration).

14. The method of claim 12, wherein the half-frame comprises a first downlink sub-frame, a special sub-frame, a first uplink sub-frame, a second uplink sub-frame, and a third uplink sub-frame (a DSUUU configuration).

15. An apparatus for channel estimation in wireless communications, comprising:
a processor;
memory in electronic communication with the processor; and
instructions stored in the memory, the instructions being executable by the processor to:
operate in a time-division duplex (TDD) scheme;
receive a first transmission in a first sub-frame of a channel according to the TDD scheme;
apply a time auto-correlation function to the first transmission to obtain a first auto-correlation sample; and
estimate at least one characteristic of the channel based at least in part on the first auto-correlation sample.

16. The apparatus of claim 15, wherein the instructions are executable by the processor to:
estimate a power spectrum density for the first transmission using the first auto-correlation sample; and
estimate a Doppler spread of the channel based at least in part on the estimated power spectrum density.

17. The apparatus of claim 15, wherein the instructions are executable by the processor to:
identify one or more previously received transmissions in one or more previous sub-frames of the channel;
apply the time auto-correlation function to a subset of the identified one or more previously received transmissions to obtain one or more auto-correlation samples; and
estimate the at least one characteristic of the channel based at least in part on the one or more auto-correlation samples.

18. The apparatus of claim 17, wherein the instructions are executable by the processor to:
identify one or more previously received transmissions in at least one downlink sub-frame or at least one special sub-frame.

19. The apparatus of claim 17, wherein the instructions are executable by the processor to:
identify a lag value for each of the one or more previous sub-frames in relation to the first sub-frame.

20. The apparatus of claim 19, wherein the instructions are executable by the processor to:
identify the subset of the identified one or more previously received transmissions based at least in part on the lag value for each of the one or more previous sub-frames.

21. The apparatus of claim 17, wherein the instructions are executable by the processor to:
identify the subset of the identified one or more previously received transmissions as transmissions received in at least one downlink sub-frame or at least one special sub-frame.

22. The apparatus of claim 15, wherein the instructions are executable by the processor to:
apply the time auto-correlation function to transmissions received in at least one downlink sub-frame or at least one special sub-frame to obtain auto-correlation samples.

23. The apparatus of claim 15, wherein the instructions are executable by the processor to:
bypass an application of the time auto-correlation function to transmissions in at least one uplink sub-frame.

24. The apparatus of claim 15, wherein the instructions are executable by the processor to:
detect a switch from operating in the TDD scheme to operating in a frequency division duplex (FDD) scheme.

25. The apparatus of claim 24, wherein the instructions are executable by the processor to:
upon detecting the switch to operating in the FDD scheme, cease to apply the time auto-correlation function to a received transmission.

26. The apparatus of claim 15, wherein the first sub-frame is part of a half-frame having a configuration according to the TDD scheme.

27. The apparatus of claim 26, wherein the half-frame comprises a first downlink sub-frame, a special sub-frame, a first uplink sub-frame, a second uplink sub-frame, and a second downlink sub-frame (a DSUUD configuration).

28. The apparatus of claim 26, wherein the half-frame comprises a first downlink sub-frame, a special sub-frame, a first uplink sub-frame, a second uplink sub-frame, and a third uplink sub-frame (a DSUUU configuration).

29. An apparatus for channel estimation in wireless communications, comprising:
means for operating in a time-division duplex (TDD) scheme;
means for receiving a first transmission in a first sub-frame of a channel according to the TDD scheme;
means for applying a time auto-correlation function to the first transmission to obtain a first auto-correlation sample; and
means for estimating at least one characteristic of the channel based at least in part on the first auto-correlation sample.

30. The apparatus of claim 29, wherein the means for estimating the at least one characteristic of the channel comprises:
means for estimating a power spectrum density for the first transmission using the first auto-correlation sample; and
means for estimating a Doppler spread of the channel based at least in part on the estimated power spectrum density.

31. The apparatus of claim 29, further comprising:
means for identifying one or more previously received transmissions in one or more previous sub-frames of the channel;
means for applying the time auto-correlation function to a subset of the identified one or more previously received transmissions to obtain one or more auto-correlation samples; and
means for estimating the at least one characteristic of the channel based at least in part on the one or more auto-correlation samples.

32. The apparatus of claim 31, wherein the means for identifying the one or more previously received transmissions in the one or more previous sub-frames comprises:
means for identifying one or more previously received transmissions in at least one downlink sub-frame or at least one special sub-frame.

33. The apparatus of claim 31, further comprising:
means for identifying a lag value for each of the one or more previous sub-frames in relation to the first sub-frame.

34. The apparatus of claim 33, further comprising:
means for identifying the subset of the identified one or more previously received transmissions based at least in part on the lag value for each of the one or more previous sub-frames.

35. The apparatus of claim 31, further comprising:
means for identifying the subset of the identified one or more previously received transmissions as transmissions received in at least one downlink sub-frame or at least one special sub-frame.

36. The apparatus of claim 29, further comprising:
means for applying the time auto-correlation function to transmissions received in at least one downlink sub-frame or at least one special sub-frame to obtain auto-correlation samples.

37. A computer program product for channel estimation in wireless communications, the computer program product comprising a non-transitory computer-readable medium storing instructions executable by a processor to:
operate in a time-division duplex (TDD) scheme;
receive a first transmission in a first sub-frame of a channel according to the TDD scheme;
apply a time auto-correlation function to the first transmission to obtain a first auto-correlation sample; and
estimate at least one characteristic of the channel based at least in part on the first auto-correlation sample

38. The computer program product of claim 37, wherein the instructions are executable by the processor to:
estimate a power spectrum density for the first transmission using the first auto-correlation sample; and
estimate a Doppler spread of the channel based at least in part on the estimated power spectrum density.

39. The computer program product of claim 37, wherein the instructions are executable by the processor to:
identify one or more previously received transmissions in one or more previous sub-frames of the channel;
apply the time auto-correlation function to a subset of the identified one or more previously received transmissions to obtain one or more auto-correlation samples; and
estimate the at least one characteristic of the channel based at least in part on the one or more auto-correlation samples.

40. The computer program product of claim 39, wherein the instructions are executable by the processor to:
identify one or more previously received transmissions in at least one downlink sub-frame or at least one special sub-frame.
